(19) United States
(12) Patent Application Publication
(10) Pub. No.: US 2005/0041703 A1
(43) Pub. Date: Feb. 24, 2005

(54) Laser system

(76) Inventors: Masayuki Momiuchi, Tokyo-to (JP); Taizo Eno, Tokyo-to (JP); Yoshiaki Goto, Tokyo-to (JP)

Correspondence Address: NIELDS & LEMACK, 176 EAST MAIN STREET, SUITE 7, WESTBORO, MA, 01581, US

(21) Appl. No.: 10/895,541

(22) Filed: Jul. 21, 2004

(30) Foreign Application Priority Data
Aug. 22, 2003 (JP) JP2003-298219
Mar. 10, 2004 (JP) JP2004-066863

(51) Int. Cl. H01S 3/13; H01S 3/00

(52) U.S. Cl. 372/29.011; 372/38.01

(57) ABSTRACT

A laser system for controlling output of a laser oscillator based on a monitor light obtained by splitting a laser beam, comprising a light emitting means for emitting the laser beam, a luminous flux splitting means disposed on an optical path of the laser beam and reflecting a part of the laser beam as a monitor light, and a photodetecting means for receiving the monitor light, wherein the luminous flux splitting means has a reflection surface of an incident angle so that reflectivity is kept at approximately constant level with respect to the laser beam regardless of condition of polarization of the incident laser beam.

### BACKGROUND OF THE INVENTION

The present invention relates to a laser system, and in particular, to a laser system for performing output control of laser.

Referring to FIG. 13, description will be given below on a conventional type laser system for output control of laser.

In FIG. 13, reference numeral 1 denotes a laser oscillator, 2 denotes a driving unit including a power source and a control unit, 3 represents a luminous flux splitting means, and 4 denotes a photodetector oppositely positioned to the luminous flux splitting means 3.

The luminous flux splitting means 3 is arranged in an optical path of a laser beam 5 outputted from the laser oscillator 1 so that the luminous flux splitting means 3 has a reflection surface at an angle of 45° to the optical path. The luminous flux splitting means 3 reflects a part (e.g. 2%-5%) of the laser beam 5, and most of the laser beam 5 are allowed to pass. The photodetector 4 receives the reflection light 6 (hereinafter referred as “monitor light 6”) reflected by the luminous flux splitting means 3, and a photodetection intensity signal is inputted to the driving unit 2.

The driving unit 2 performs auto power control (APC) on the laser oscillator 1 so that light intensity of the monitor light 6 is kept at a constant value.

FIG. 14 shows a case where the laser oscillator 1 is a diode pumped solid-state laser. In FIG. 14, the same component as shown in FIG. 13 is referred by the same symbol. Also, the laser oscillator 1 shown in FIG. 14 is a diode pumped solid-state laser of intracavity type SHG mode, which converts frequency of the laser beam from the semiconductor laser.

In FIG. 14, reference numeral 8 denotes a light emitting unit, and 9 denotes an optical resonator. The light emitting unit 8 comprises an LD light emitter 11 as a light emitting means, and a condenser lens 12. Further, the optical resonator 9 comprises a laser crystal 14 with a first dielectric reflection film 13 formed on the laser crystal 14, a non-linear optical medium (NLO) 15, and a concave mirror 17 with a second dielectric reflection film 16 formed on the concave mirror 17. In the optical resonator 9, pumping is performed for the laser beam, and it is outputted after being resonated and amplified. As the laser crystal 14, Nd:YVO₄ may be used. As the non-linear optical medium 15, KTP (KTiOPO₄; titanyl potassium phosphate) may be used. The first dielectric reflection film 13 and the second dielectric reflection film 16 are coated by evaporation, sputtering, etc.

The LD light emitter 11 is used to emit, for instance, a linearly polarized laser beam with wavelength of 809 nm as an excitation light. A semiconductor laser 11a is used as a light emitting element. The laser light emitting means is not limited to the semiconductor laser, and any type of laser light emitting means may be used so far as the laser light emitting means can generate a laser beam.

The laser crystal 14 performs amplification of light. As the laser crystal 14, Nd:YVO₄ with an oscillation line of 1064 nm is used. Further, YAG (yttrium aluminum garnet) doped with Nd³⁺ ions may be used. YAG has oscillation lines of 946 nm, 1064 nm, 1319 nm, etc. Ti (sapphire) with oscillation lines of 700-900 nm may be used.

The first dielectric reflection film 13 is highly transmissive to the laser beam from the LD light emitter 11, and the first dielectric reflection film 13 is highly reflective to an oscillation wave (fundamental wave) of the laser crystal 14. Also, the first dielectric reflection film 13 is highly reflective to a wavelength conversion light, e.g. secondary higher harmonic wave (SHG: second harmonic generation).

The concave mirror 17 is oppositely positioned to the laser crystal 14. The surface of the concave mirror 17 closer to the laser crystal 14 is fabricated to have a form of a concave spherical mirror with an appropriate radius, and the second dielectric reflection film 16 is formed on the concave mirror 17. The second dielectric reflection film 16 is highly reflective to an oscillation wave (fundamental wave) of the laser crystal 14, and the second dielectric reflection film 16 is highly transmissive to SHG.

As described above, when the first dielectric reflection film 13 of the laser crystal 14 is combined with the second dielectric reflection film 16 of the concave mirror 17 and pumping is performed to the laser beam from the LD light emitter 11 via the condenser lens 12 on the laser crystal 14, light runs reciprocatingly between the first dielectric reflection film 13 of the laser crystal 14 and the second dielectric reflection film 16, and the light can be confined for long time. As a result, the light can be resonated and amplified.

The non-liner optical medium 15 is placed within an optical resonator, which comprises the first dielectric reflection film 13 of the laser crystal 14 and the concave mirror 17. When a strong coherent light such as a laser beam enters the non-linear optical medium 15, a secondary higher harmonic wave (SHG) with light frequency by two times is generated. The generation of the secondary higher harmonic wave (SHG) is called “second harmonic generation”. Therefore, a laser beam with wavelength of 532 nm is emitted from the laser oscillator 1.

In the laser oscillator 1, the non-linear optical medium (hereinafter referred as “wavelength conversion element”) 15 is placed in the optical resonator, which comprises the laser crystal 14 and the concave mirror 17, and it is called internal type SHG. Conversion output is proportional to a square of excited photoelectric power. This provides an effect that high optical intensity in the optical resonator can be directly utilized.

In the solid-state laser system as shown in FIG. 14, the secondary higher harmonic wave (hereinafter referred as “wavelength conversion light” generated at the wavelength conversion element 15 is projected from both of an end surface of the wavelength conversion element 15 closer to the concave mirror 17 and from an end surface closer to the laser crystal 14. The wavelength conversion light projected directly from the end surface closer to the concave mirror 17 is projected through the second dielectric reflection film 16 and the concave mirror 17. The wavelength conversion light projected from the end surface closer to the laser crystal 14 passes through the laser crystal 14 and is reflected by the first dielectric reflection film 13, and the wavelength conversion light is projected through the wavelength conversion element 15, the second dielectric reflection film 16 and the concave mirror 17.

The laser crystal 14 has an action as a wave plate. When the wavelength conversion light passes through the laser crystal 14, the plane of polarization is rotated and it is turned to an elliptically polarized light. Therefore, the wavelength conversion light projected from the concave mirror 17 is turned to a laser beam, which comprises elliptically polarized light components, including both types of linearly polarized light components (i.e. p-linearly polarized light and s-linearly polarized light).

Each of the p-linearly polarized light and the s-linearly polarized light has such characteristics that reflectivity changes according to an incident angle, at which the light enters the reflection surface. FIG. 15 shows the change of reflectivity corresponding to the change of the incident angle of each of the p-linearly polarized light and the s-linearly polarized light. From FIG. 15, we can see as follows: For both p-linearly polarized light and s-linearly polarized light, reflectivity is approximately at constant level when the incident angle is from 0 to about 10°. For the s-linearly polarized light, reflectivity is gradually increased until the incident angle reaches 90°. For the p-linearly polarized light, reflectivity is decreased until the incident angle reaches about 56°. The reflectivity is about 0 when the incident angle is about 56°. Thereafter, the reflectivity increases until the incident angle reaches 90°. When the incident angle is 90°, reflectivity of the p-linearly polarized light is consistent with that of the s-linearly polarized light.

As shown in FIG. 16, when an anti-reflective film (AR coat) is used on the reflection surface, reflectivity differs between the p-linearly polarized light and the s-linearly polarized light when reflection suppressive wavelength λ1 of the formed anti-reflective film is deviated from an object wavelength λ0. The difference of reflectivity is increased corresponding to the amount of deviation.

The ratio of the p-linearly polarized light component to the s-linearly polarized light component changes according to the temperature of the laser oscillator 1. Therefore, in the laser beam reflected by the luminous flux splitting means 3 positioned at an angle of 45° with respect to the optical path, light intensity of the monitor light 6 varies depending on the change of the ratio of the p-linearly polarized light component to the s-linearly polarized light component even when light intensity of the outputted laser beam 5 is at constant level. For instance, the p-polarized light component is not reflected almost at all when the incident angle is near 56°, and only the s-polarized light is received. Thus, actual intensity of the laser beam cannot be detected. For this reason, there has been such problem that it is not possible to perform auto power control with high accuracy.

When auto power control is carried out on a light emitting means provided with two or more semiconductor lasers 11a, it is difficult to achieve auto power control for each individual semiconductor laser 11a, and auto power control is performed for all. In particular, in a semiconductor laser array with the semiconductor lasers 11a arranged in form of a column or a matrix, it is not possible to emit light independently with each semiconductor laser 11a, and auto power control of each semiconductor laser 11a cannot be performed. For this reason, it is difficult to monitor output change of each semiconductor laser 11a and the ratio of the p-linearly polarized light component to the s-linearly polarized light component. It is difficult to perform output control of the laser oscillator 1 by obtaining the monitor light 6 from the luminous flux splitting means 3, and it is a problem that the accuracy is low. Therefore, there has been no other way but to perform auto current control in conventional type.

When the light emitting means provided with two or more semiconductor lasers 11a to emit laser beams with different wavelengths (different colors) is used and when the anti-reflective film is formed on the reflection surface of the luminous flux splitting means 3 for the purpose of suppressing the loss of light at the luminous flux splitting means 3, it is difficult to form the anti-reflective film to two or more wavelengths, and this leads to higher cost. Even when an adequate anti-reflective film is formed, there is reflectivity of 2% or lower, and this is sufficient as the light amount of the monitor light 6.

### SUMMARY OF THE INVENTION

It is an object of the present invention to provide a laser system, by which it is possible to perform auto power control of an emitted laser beam in reliable manner and with high accuracy regardless of the condition of polarization of a light emitting means, even in a light emitting means provided with two or more light emitting elements, and even in a light emitting means provided with light emitting elements for emitting two or more of laser beams with different wavelengths.

To attain the above object, the present invention provides a laser system for controlling output of a laser oscillator based on a monitor light obtained by splitting a laser beam, comprising a light emitting means for emitting the laser beam, a luminous flux splitting means disposed on an optical path of the laser beam and reflecting a part of the laser beam as a monitor light, and a photodetecting means for receiving the monitor light, wherein the luminous flux splitting means has a reflection surface of an incident angle so that reflectivity is kept at approximately constant level with respect to the laser beam regardless of condition of polarization of the incident laser beam. Also, the present invention provides the laser system as described above, wherein the incident angle is less than about 10°. Further, the present invention provides the laser system as described above, wherein the light emitting means has a diode pumped solid-state laser. Also, the present invention provides the laser system as described above, wherein the light emitting means has two or more diode pumped solid-state lasers. Further, the present invention provides the laser system as described above, wherein the two or more diode pumped solid-state lasers project two or more laser beams with different wavelengths. Also, the present invention provides the laser system as described above, wherein there is provided a case to accommodate the light emitting means, and the luminous flux splitting means is a transparent member provided on a laser beam projecting window of the case.

Further, the present invention provides the laser system as described above, wherein there is provided a light guiding optical means for guiding the monitor light from the luminous flux splitting means toward the photodetecting means. Also, the present invention provides the laser system as described above, wherein the luminous flux splitting means is an end surface of a fiber provided to have an incident angle of less than 10°.

Further, the present invention provides the laser system as described above, wherein the light guiding optical means is a light guiding fiber. Also, the present invention provides the laser system as described above, wherein it is designed in such manner that the monitor light is projected to the light guiding fiber via a reflection mirror. Further, the present invention provides the laser system as described above, wherein it is designed in such manner that the monitor light enters from a forward peripheral surface to an inner surface of an end surface of the light guiding fiber.

The present invention provides a laser system for controlling output of a laser oscillator based on a monitor light obtained by splitting a laser beam, comprising a light emitting means for emitting the laser beam, a luminous flux splitting means disposed on an optical path of the laser beam and reflecting a part of the laser beam as a monitor light, and a photodetecting means for receiving the monitor light, wherein the luminous flux splitting means has a reflection surface of an incident angle so that reflectivity is kept at approximately constant level with respect to the laser beam regardless of condition of polarization of the incident laser beam. As a result, even when the condition of polarization of the projected laser beams is changed, the monitor light accurately reflects light intensity of the projection, and it is possible to perform output control with high accuracy.

Also, according to the present invention, when the reflection surface of the luminous flux splitting means is set to the incident angle with respect to the laser beam, reflectivity is not changed with respect to the wavelength. Thus, it is possible to perform auto power control for the projected laser beam in reliable manner and with high accuracy even for the light emitting means provided with the light emitting elements emitting two or more laser beams with different wavelengths.

According to the present invention, the light guiding optical means is a light guiding fiber. This contributes to the improvement of the degree of freedom in the positioning of the photodetector and also to compact design of the module.

### BRIEF DESCRIPTION OF THE DRAWINGS

FIG. 1 is a schematical drawing of a first embodiment of the present invention;

FIG. 2 is a drawing to explain a luminous flux splitting means part in the first embodiment of the present invention;

FIG. 3 is a schematical drawing of a second embodiment of the present invention;

FIG. 4 is a schematical drawing of a third embodiment of the present invention;

FIG. 5 is a plan view showing approximate arrangement of a fourth embodiment of the present invention;

FIG. 6 is a schematical elevation view of the fourth embodiment of the present invention;

FIG. 7(A), FIG. 7(B), FIG. 7(C) and FIG. 7(D) each represents a drawing to explain a light guiding optical means.

FIG. 8 is a plan view showing approximate arrangement of a fifth embodiment of the present invention;

FIG. 9 is a schematical drawing of a sixth embodiment of the present invention;

FIG. 10 is an enlarged view of an essential portion of the sixth embodiment of the present invention;

FIG. 11 is a schematical drawing of a seventh embodiment of the present invention;

FIG. 12 is an enlarged view of an essential portion of the seventh embodiment of the invention;

FIG. 13 is a schematical block diagram of a conventional example;

FIG. 14 is a schematical block diagram of another conventional example;

FIG. 15 is a graph showing reflectivity of polarized light corresponding to an incident angle; and

FIG. 16 is a graph showing relation between wavelength and reflectivity in case an anti-reflection film is provided.

### DETAILED DESCRIPTION OF THE PREFERRED EMBODIMENTS

Description will be given below on the best mode for executing the present invention referring to the drawings.

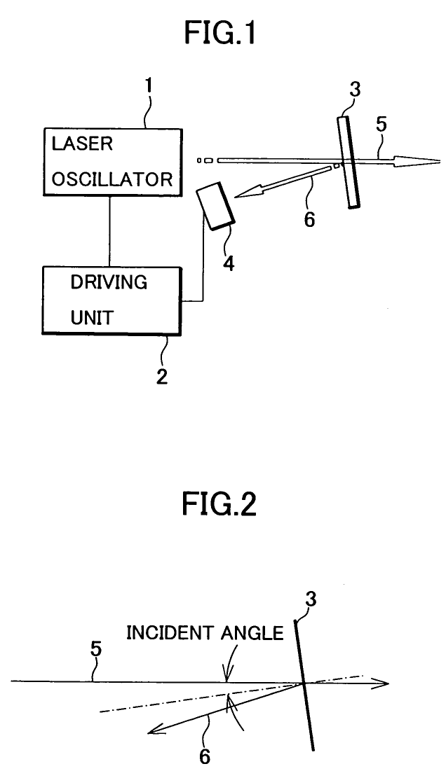

Description will be given on a first embodiment referring to FIG. 1 and FIG. 2.

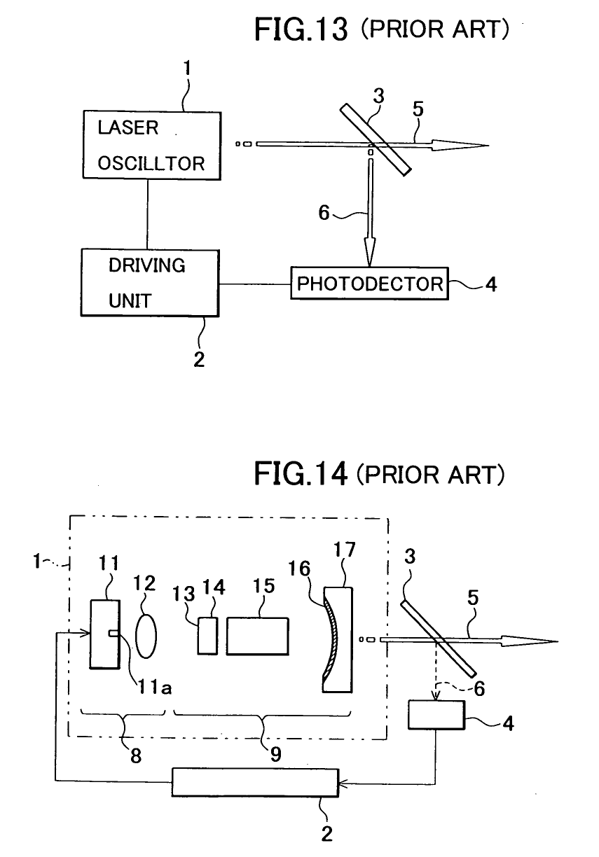

In FIG. 1, the equivalent component as shown in FIG. 13 is referred by the same symbol.

On an optical path of a laser beam 5 emitted from a laser oscillator 1, a luminous flux splitting means 3 is provided. The luminous flux splitting means 3 is arranged in such manner that the laser beam 5 enters a reflection surface at an angle of less than about 10°. A photodetector (photodetection means) 4 for receiving a reflection light from the luminous flux splitting means 3 is oppositely positioned to the luminous flux splitting means 3.

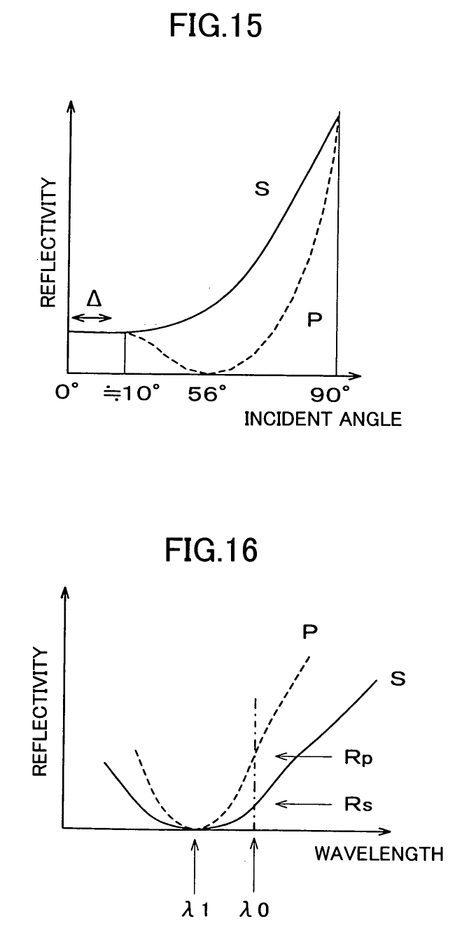

As shown in FIG. 15, when a laser beam enters at an incident angle of less than about 10° with respect to a reflection surface, reflectivity is approximately on a constant level for both p-linear polarized light and s-linear polarized light. Further, the present inventors have also confirmed that reflectivity is approximately constant for both p-linearly polarized light and s-linearly polarized light regardless of a wavelength when the laser beam enters at an angle of less than about 10°.

The present invention utilizes the reflection characteristics of the laser beam.

Specifically, it is designed that the laser beam 5 enters the reflection surface of the luminous flux splitting means 3 at an angle of less than about 10°. Thus, even when polarizing condition of the laser beam 5 varies and a ratio of p-linearly polarized light component to s-linearly polarized light component changes, reflectivity of each of the p-linearly polarized light and the s-linearly polarized light does not change. The laser beam reflected by the luminous flux splitting means 3, i.e. a monitor light 6, accurately reflects light intensity of the laser beam 5 at all times.

Therefore, the laser oscillator 1 can be placed under auto power control with high accuracy by controlling the output of the laser oscillator 1 so that photodetection intensity of the photodetector 4 can be at a constant level based on a photodetection signal inputted from the photodetector 4.

It would suffice that the luminous flux splitting means 3 can slightly reflect the laser beam 5. For instance, A transparent member, e.g. glass, may be used which is provided in order to block a laser beam exit window of a housing for accommodating the laser oscillator 1, etc. The glass of the exit window is mounted at tilting of less than about 10° with respect to the laser beam 5, and the reflection light from the glass may be used as the monitor light 6.

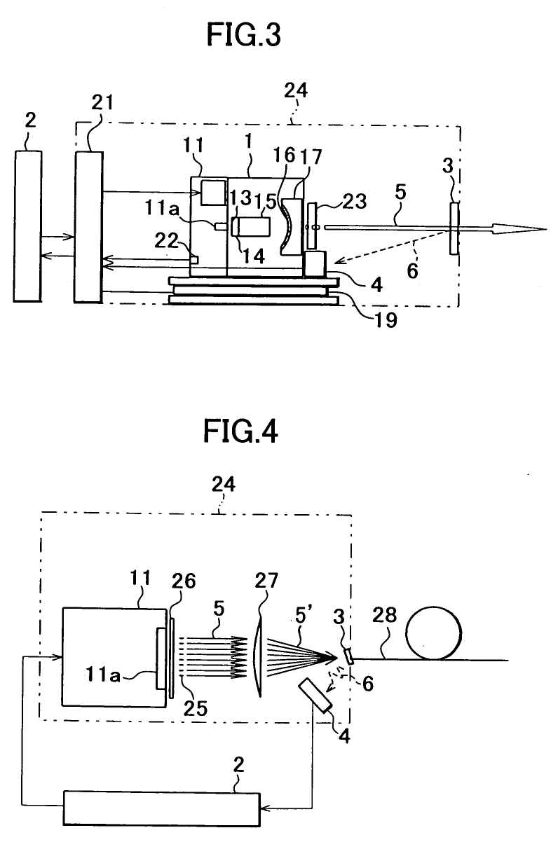

FIG. 3 shows a second embodiment, in which the present invention is applied to a diode pumped solid-state laser as shown in FIG. 14. In FIG. 3, the equivalent component as in FIG. 14 is referred by the same symbol.

The laser oscillator 1 shown in FIG. 3 is a diode pumped solid-state laser of intracavity type SHG mode for converting frequency of a laser beam from a semiconductor laser. An excitation light emitted from the LD light emitter 11 is converted to a fundamental light at the laser crystal 14. Further, the fundamental light is converted by wavelength conversion to a secondary higher harmonic wave at the non-linear optical medium 15.

The LD light emitter 11, the laser crystal 14, the non-linear optical medium 15, and the concave mirror 17, etc. are composed as an integrated the laser oscillator 1, and the laser oscillator 1 is placed on a chiller 19 such as a thermoelectric cooling element (TEC).

The driving unit 2 can drive and control the LD light emitter 11 and the chiller 19 via an input/output unit 21. A temperature sensor 22 is provided to detect temperature of the LD light emitter 11, the first dielectric reflection film 13, and the non-linear optical medium 15, and the temperature sensor 22 and the photodetector 4 are connected to the driving unit 2 via the input/output unit 21.

In FIG. 3, reference numeral 23 denotes a filter oppositely positioned to the concave mirror 17. The filter 23 cuts off lights leaking out of the laser oscillator 1 such as unnecessary excitation light and infrared light such as the fundamental light, etc. and allows only the SHG light to pass.

The laser oscillator 1, the input/output unit 21, and the chiller 19 are placed in a case 24, which is sealed or more preferably liquid-tightly sealed, and the laser oscillator 1, the input/output unit 21 and the chiller 19 are designed as a module. On the laser beam exit window of the case 24, the luminous flux splitting means 3 is provided at an angle of less than about 10° with respect to the optical path, and the monitor light 6 reflected by the luminous flux splitting means 3 enters the photodetector 4.

The excitation light emitted from the semiconductor laser 11a is converted to a fundamental light by the laser crystal 14. Further, it is subjected to wavelength conversion at the non-linear optical medium 15, and a wavelength conversion light is generated. A part of the wavelength conversion light is projected directly from an end surface of the non-linear optical medium 15 closer to the second dielectric reflection film 16 via the second dielectric reflection film 16. The remainder of the wavelength conversion light passes through the laser crystal 14 and is reflected by the first dielectric reflection film 13. Then, it passes through the non-linear optical medium 15 and is projected via the second dielectric reflection film 16. The laser crystal 14 has an action as a wave plate. When the remainder of the wavelength conversion light passes through the laser crystal 14, the remainder of the projected wavelength conversion light is turned to an elliptically polarized light including p-linearly polarized light component and s-linearly polarized light component.

A part of the wavelength conversion light (laser beam 5) projected from the laser oscillator 1 is reflected by the luminous flux splitting means 3. The monitor light 6 reflected by the luminous flux splitting means 3 is received by the photodetector 4, and a photodetection signal is sent to the driving unit 2 via the input/output unit 21. The driving unit 2 controls the output of the LD light emitter 11 via the input/output unit 21 based on the photodetection signal. Temperature of each of the LD light emitter 11, the laser crystal 14, and the non-linear optical medium 15 is detected by the temperature sensor 22. Based on the detected temperature on the temperature sensor 22, the chiller 19 is driven and controlled via the input/output unit 21, and chilling is performed so that the temperature of each of the LD light emitter 11, the laser crystal 14, and the non-linear optical medium 15 is maintained at a predetermined value.

The laser beam 5 is an elliptically polarized light, and the action as a wave plate of the laser crystal 14 is changed according to the temperature of the laser crystal 14. Thus, the ratio of the p-linearly polarized light component to the s-linearly polarized light component of the laser beam 5 also changes.

The reflection surface of the luminous flux splitting means 3 is tilted at an angle of less than about 10° with respect to the laser beam 5. Accordingly, reflectivity of the luminous flux splitting means 3 is approximately constant with respect to the p-linearly polarized light and the s-linearly polarized light. The monitor light 6 reflected by the luminous flux splitting means 3 accurately reflects light intensity of the laser beam 5. Therefore, the driving unit 2 can drive the laser oscillator 1 by auto power control with high accuracy.

FIG. 4 shows a third embodiment of the present invention. In the third embodiment, the LD light emitter 11 turns two or more semiconductor lasers 11a to form of a straight line or a matrix. Further, the laser crystal 14 corresponding to each semiconductor laser 11a is integrated with the non-linear optical medium 15. The first dielectric reflection film 13 is formed on an end surface of the laser crystal 14, and the second dielectric reflection film 16 is formed on an end surface of the non-linear optical medium 15. The laser oscillator 1 is turned to form of a chip, and the chips are aligned in form of a straight line or a matrix to make up a wavelength conversion unit 25.

The excitation light projected from each of the semiconductor lasers 11a is turned to an approximately parallel beam by a collimator lens 26 of cylindrical shape and the beams are projected to the wavelength conversion unit 25 and are subjected to wavelength conversion. Further, the beams are bundled to a single laser beam 5′ by a collimator lens 27 and this is projected to a light guiding means 28 such as an optical fiber. The luminous flux splitting means 3 is provided so that the laser beam 5′ enters there, and the luminous flux splitting means 3 is provided so that it has an incident angle of less than about 10° with respect to all of the laser beams 5′.

The semiconductor lasers 11a each may emit laser beams with the same wavelength or laser beams with different wavelengths. When the semiconductor lasers 11a with different wavelengths are used, laser beams with different colors can be projected by turning on or off the semiconductor lasers 11a. The present invention can be applied to a light source for a device such as a projector.

The third embodiment as shown in FIG. 4 can be applied to a case where relatively high laser beam intensity is required, e.g. in a medical system such as a laser operation system. In case two or more laser beams 5 are bundled together and are used, it is preferable to perform auto power control of overall output of the laser beams 5′ bundled together rather than to perform auto power control for each of the laser beams.

The monitor light 6 reflected by the luminous flux splitting means 3 is reflected at the same reflectivity to each of the laser beams 5 regardless of the condition of polarization and wavelength of each of the laser beams 5. Thus, the monitor light 6 generated as the result of the reflection of the laser beams 5′ by the luminous flux splitting means 3 accurately corresponds to overall output of the laser beam 5′.

Regardless of the condition of polarization and wavelength of each of the laser beams 5, auto power control with high accuracy can be carried out to overall output of the laser beams 5′.

In the present embodiment, the luminous flux splitting means 3 may not be separately provided. Instead, it may be designed in such manner that an end surface on an incident side of the light guiding means 28 is set at an angle of less than 10 with respect to the incident angle of the laser beam and the end surface of the light guiding means 28 may be used as the luminous flux splitting means 3.

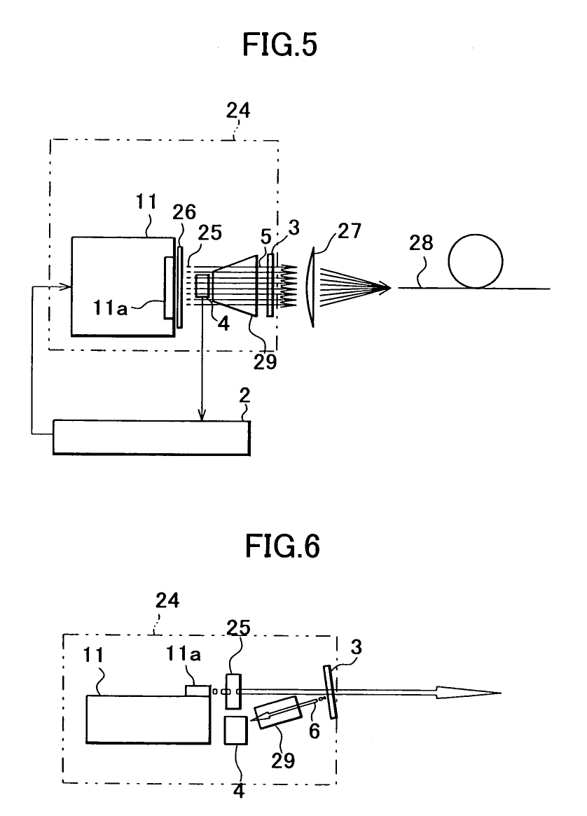

FIG. 5 and FIG. 6 each represents a fourth embodiment of the present invention. In the fourth embodiment, the light emitting means is provided with two or more semiconductor lasers 11a. The luminous flux splitting means 3 is provided so that the laser beam 5 is split before the beams are bundled together. In the fourth embodiment, a light guiding optical means 29 is provided for guiding the monitor light 6 split by the luminous flux splitting means 3 toward the photodetector 4. By providing the light guiding optical means 29, the limitation to the arrangement position of the photodetector 4 is reduced, and this provides an effect to increase the degree of freedom in designing.

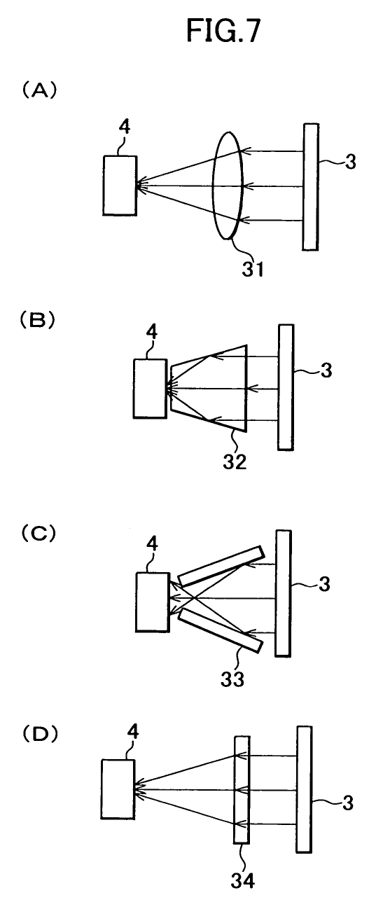

FIG. 7(A) represents a case where a condenser lens 31 is used as the light guiding optical means 29. FIG. 7(B) shows a case where a trapezoidal prism 32 with its cross-section gradually reducing toward an exit side is used as the light guiding optical means 29. FIG. 7(C) shows a case where a duct 33, which is a hollow member with cross-section gradually reducing toward an exit side and has an inner surface as a reflection surface, is used as the light guiding optical means 29. FIG. 7(D) shows a case where a diffraction optical member 34 is used as the light guiding optical means 29.

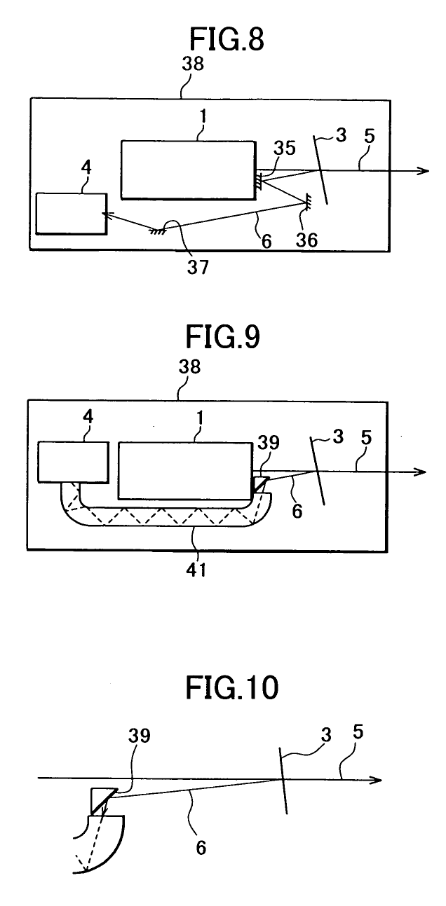

FIG. 8 represents a fifth embodiment. In this embodiment, reflection mirrors 35, 36, and 37 are used as the light guiding optical means 29 for guiding the monitor light 6 reflected by the luminous flux splitting means 3 toward the photodetector 4. By reflecting sequentially by means of the reflection mirrors 35, 36 and 37 and by guiding the monitor light 6 toward the photodetector 4, there is no need to place the photodetector 4 near the luminous flux splitting means 3. This increases the degree of freedom in the positioning of the photodetector 4 and this is helpful to achieve compact design of a module 38.

It may be designed in such manner that only the reflection mirror 35 or only the reflection mirrors 35 and 36 are used instead of the reflection mirrors 35, 36 and 37 and the monitor light 6 reflected by the reflection mirror 35 or the monitor light 6 reflected by the reflection mirror 36 may be guided to the photodetector 4 by the light guiding means such as an optical fiber.

FIG. 9 and FIG. 10 each represents a sixth embodiment. A micro mirror 39 is used as the reflection mirror 35 shown in FIG. 8. One end surface of an optical fiber 41 is oppositely positioned to the micro mirror 39. The monitor light 6 reflected by the micro mirror 39 is projected to the optical fiber 41, and the monitor light 6 is guided toward the photodetector 4 by the optical fiber 41. In the sixth embodiment, the end surface of the optical fiver 41 can be placed near the luminous flux splitting means 3. Thus, the monitor light 6 can be projected to the optical fiber 41 before the monitor light 6 is diffused. This reduces the need of the strict positioning accuracy of the optical fiber 41 and facilitates the manufacture of the module 38.

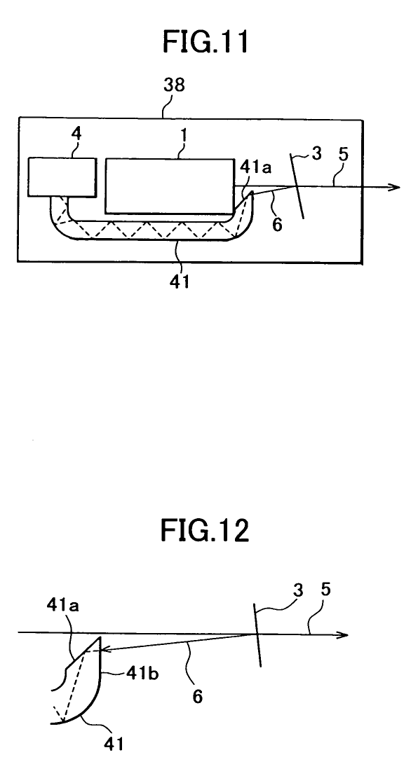

Further, FIG. 11 and FIG. 12 each represents a seventh embodiment. In the seventh embodiment, the micro mirror 39 is not used, and the monitor light 6 is guided toward the photodetector 4 only by the optical fiber 41.

An end surface 41a of the optical fiber 41 is set at a certain required angle and an inner surface of the end surface 41a (a surface closer to inside of the optical fiber 41) is oppositely positioned to the luminous flux splitting means 3 via a forward peripheral surface 41b.

The monitor light 6 split by the luminous flux splitting means 3 enters the optical fiber 41 via the forward peripheral surface 41b and is reflected by the end surface 41a. Then, the monitor light 6 propagates through the optical fiber 41 and is guided toward the photodetector 4.

In the seventh embodiment, a gap between the laser oscillator 1 and the luminous flux splitting means 3 may be reduced to such a size that the forward end of the optical fiber 41 can enter, and this is helpful to achieve more compact design of the module 38. An AR film (anti-reflection film) may be coated on the forward peripheral surface 41b so that the monitor light 6 can efficiently enter the end surface 41a.

In the sixth and the seventh embodiments, the light guiding optical means 29 may be made of a material (light guiding fiber) with transmissivity such as acrylic resin instead of an optical fiber.

1. A laser system for controlling output of a laser oscillator based on a monitor light obtained by splitting a laser beam, comprising a light emitting means for emitting the laser beam, a luminous flux splitting means disposed on an optical path of the laser beam and reflecting a part of the laser beam as a monitor light, and a photodetecting means for receiving the monitor light, wherein said luminous flux splitting means has a reflection surface of an incident angle so that reflectivity is kept at approximately constant level with respect to the laser beam regardless of condition of polarization of the incident laser beam.

2. A laser system according to claim 1, wherein said incident angle is less than about 10°.

3. A laser system according to claim 1, wherein said light emitting means has a diode pumped solid-state laser.

4. A laser system according to claim 1, wherein said light emitting means has two or more diode pumped solid-state lasers.

5. A laser system according to claim 4, wherein said two or more diode pumped solid-state lasers project two or more laser beams with different wavelengths.

6. A laser system according to claim 1, wherein there is provided a case to accommodate said light emitting means, and said luminous flux splitting means is a transparent member provided on a laser beam projecting window of said case.

7. A laser system according to claim 1, wherein there is provided a light guiding optical means for guiding the monitor light from said luminous flux splitting means toward said photodetecting means.

8. A laser system according to claim 1, wherein said luminous flux splitting means is an end surface of a fiber provided to have an incident angle of less than 10°.

9. A laser system according to claim 7, wherein said light guiding optical means is a light guiding fiber.

10. A laser system according to claim 9, wherein it is designed in such manner that the monitor light is projected to said light guiding fiber via a reflection mirror.

11. A laser system according to claim 9, wherein it is designed in such manner that the monitor light enters from a forward peripheral surface to an inner surface of an end surface of said light guiding fiber.
